(19) United States
(12) Patent Application Publication
(10) Pub. No.: US 2025/0342440 A1
(43) Pub. Date: Nov. 6, 2025

(54) Method and system for distributed inventory tracking and management

(71) Applicant: Product Sightings, Inc. d/b/a/ Youdle, Memphis, TN (US)

(72) Inventors: Kontji Renee Anthony, Memphis, TN (US); Aurora Elizabeth Anthony, New Rochelle, NY (US); Johnita Likoau Anthony, Rochester, NY (US)

(73) Assignee: Product Sighting, Inc. d/b/a/ Youdle, Memphis, TN (US)

(21) Appl. No.: 19/200,216

(22) Filed: May 6, 2025

Related U.S. Application Data
(60) Provisional application No. 63/643,066, filed on May 6, 2024.

(51) Int. Cl. G06Q 10/0875

(52) U.S. Cl. CPC G06Q 10/0875

(57) ABSTRACT

A computer-implemented method for tracking inventory levels comprises receiving a plurality of stock verifications for a plurality of items from multiple input sources within a distributed network of input sources. The method involves generating an initial inventory list based on these stock verifications, where the initial inventory list includes a first stock value for a first item in inventory at a first point in time. The method further involves displaying the initial inventory list that includes the first stock value for the first item in inventory at the first point in time. Subsequently, the method includes receiving an updated stock verification from an input source within the distributed network, which includes an updated stock value for the first item at a second point in time. The method also generates an updated inventory list that incorporates the updated stock value for the first item and displays the updated inventory list accordingly.

### RELATED APPLICATIONS

This application claims the benefit of priority to U.S. Provisional Patent Application No. 63/643,066, filed on May 6, 2024, the entirety of which is incorporated herein by reference.

### BACKGROUND

In the field of inventory management, the precise tracking and real-time updating of stock levels present considerable challenges. The demand for effective inventory management solutions has surged with the advent of mobile shopping and digitized retail platforms. Conventional inventory management systems employed by larger retailers often lack the flexibility and scalability required by smaller, underserved retailers, who may not possess the resources to implement sophisticated technology solutions.

Existing inventory management systems predominantly rely on centralized data collection from point-of-sale systems and retailer inputs. Such systems frequently suffer from inaccuracies due to delayed updates, human error, and inflexible data integration methods. Consequently, this results in inadequate real-time visibility into inventory levels, further exacerbating inefficiencies in supply chain coordination. Moreover, standard systems fail to adequately engage end-users in the inventory verification process, which can provide a wealth of data through community participation and diverse perspectives.

Inaccurate inventory data can significantly impact consumers by causing disruptions in the availability of desired products. When inventory levels are not precisely tracked or updated in real-time, consumers may encounter low stock events or unexpected shortages, leading to frustration and diminished consumer satisfaction. Such inaccuracies can result in missed sales opportunities for retailers, as consumers who are unable to find the products they seek may turn to alternative vendors or abandon their purchase attempts altogether. Moreover, unreliable inventory records hinder effective planning and forecasting, as consumers and retailers struggle to make informed decisions based on outdated or erroneous information. This not only affects immediate purchase decisions but also influences long-term consumer trust and loyalty, as repeated inventory inaccuracies erode confidence in the retailer's ability to fulfill consumer needs consistently. Therefore, ensuring accurate and up-to-date inventory data can be crucial for maintaining a positive consumer experience and fostering sustained business growth.

Efforts to incorporate user-driven data collection methodologies, such as crowdsourcing, in conventional systems have experienced obstacles due to insufficient motivation for user participation and challenges in ensuring data accuracy and reliability. Furthermore, present systems do not optimally leverage modern technological advancements, such as geolocation capabilities and augmented reality, which have potential to provide valuable contextual inventory information and enhance user engagement by personalizing the interaction experience.

What is needed is an adaptable inventory management system that effectively integrates real-time data inputs from multiple sources, including community users, and utilizes these inputs to maintain accurate, up-to-the-minute inventory records. Such a system should incorporate incentive mechanisms to encourage participation, employ location-based alerts for relevance, and utilize predictive analytics to forecast inventory needs proactively. This approach would address existing gaps by combining technology-driven functionalities with user-centric participation, thereby providing small retailers with the tools necessary to improve their inventory management processes.

### SUMMARY

According to one aspect of the disclosure, a computer-implemented method for tracking inventory levels can include receiving a plurality of stock verifications for a plurality of items from multiple input sources within a distributed network of input sources. The method can include generating an initial inventory list based on these stock verifications, where the initial inventory list can include a first stock value for a first item in inventory at a first point in time. The method further can include displaying the initial inventory list that can include the first stock value for the first item in inventory at the first point in time. Subsequently, the method can include receiving an updated stock verification from an input source within the distributed network, which can include an updated stock value for the first item at a second point in time. The method also generates an updated inventory list that incorporates the updated stock value for the first item and displays the updated inventory list accordingly.

In addition to one or more of the features described herein, or as an alternative, further embodiments of the computer-implemented method may include an incentive system that motivates the plurality of input sources to provide stock verifications. In some embodiments, the stock verifications may include at least one of the stock values or a stock image. The incentive system may be configured to provide an incentive upon receiving stock verifications, where the incentive may include options such as cash, a cash-equivalent credit, or a product discount.

In further embodiments, the computer-implemented method may can include the updated stock value being different from the initial stock value. The method may also include a feature whereby the plurality of stock verifications each correspond to a specific location, and at least one of the input sources may be alerted when it is within a certain distance of that location.

The method may further encompass defining a threshold stock value, defining an end time corresponding to a future restocking event, and predicting whether a future stock value will fall below the threshold stock value before the end time.

Additionally, the method may include determining an inventory trend based on at least the initial stock value and the updated stock value. There may also be a mechanism to alert at least one of the input sources when the updated stock value falls below a threshold stock value.

According to another aspect of the disclosure, a system for tracking inventory levels across a plurality of locations can include a processor programmed to receive a plurality of stock verifications for a plurality of items from various input sources associated with a distributed network of input sources. The processor generates an initial inventory list based on the plurality of stock verifications, where the initial inventory list can include a first stock value for a first item in inventory at a first point in time, and displays the initial inventory list that can include the first stock value for the first item inventory at the first point in time. The processor further receives an updated stock verification that can include an updated stock value for the first item at a second point in time from an input source within the distributed network of input sources, generates an updated inventory list that can include the updated stock value for the first item, and displays the updated inventory list that can include the updated stock value for the first item.

### BRIEF DESCRIPTION OF THE DRAWINGS

FIG. 1 is a flowchart illustrating a computer-implemented method for tracking inventory levels.

FIG. 2 is a flowchart depicting the implementation of an incentive system within the inventory tracking method.

FIG. 3 is a flowchart detailing the process for providing incentives based on stock verifications.

FIG. 4 is a flowchart illustrating the verification of stock at a location and subsequent alerting of input sources.

FIG. 5 is a flowchart illustrating a method for predicting inventory stock levels based on threshold values and restocking events.

FIG. 6 is a block diagram of a system for tracking inventory levels, comprising various components like a CPU, storage medium, and input/output devices.

### DETAILED DESCRIPTION

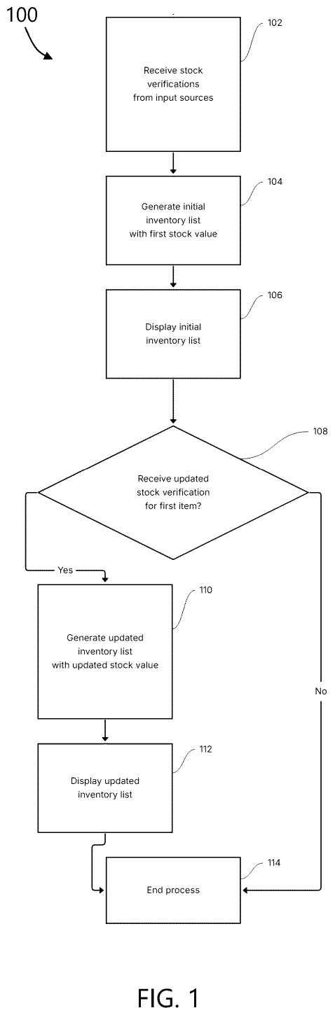

FIG. 1 is a flowchart illustrating a computer-implemented method 100 for tracking inventory levels. At step 102, stock verifications are received from input sources, which may include retailers, point-of-sale systems, and mobile shoppers. These verifications are then utilized at step 104 to generate an initial inventory list based on a first stock value. At step 106, the initial inventory list is displayed, allowing for visibility of the current stock levels. The process then evaluates, at step 108, whether an updated stock verification for the first item has been received. If an updated verification is obtained, the process moves to step 110, where an updated inventory list with an amended stock value can be generated.

Subsequently, at step 112, this updated inventory list can be displayed, ensuring that the most current data can be available for review. Finally, the process concludes at step 114, completing the inventory tracking sequence. This method enables real-time tracking and updating of inventory levels, ensuring efficient management for community grocers and mobile shoppers.

Referring now to FIG. 1, at step 102, the process of receiving stock verifications can be performed by capturing data inputs from multiple sources within a distributed network of input devices. These sources include retailers, point-of-sale systems, and mobile shoppers. Each source contributes to the plurality of stock verifications that are utilized in the computer-implemented method for inventory tracking. Retailers may provide direct data feeds from their transaction systems, while point-of-sale systems supply information as transactions occur. Mobile shoppers contribute by submitting stock verifications via mobile interfaces, which may include data entries or images captured from shelves or inventory displays. The collected stock verification data can be then aggregated to form an initial inventory list, ensuring that current inventory levels are accurately reflected. This mechanism allows for real-time visibility and monitoring of stock, thereby facilitating efficient inventory management.

At step 104, an initial inventory list can be generated based on the plurality of stock verifications received at step 102. This initial inventory list includes a first stock value for a first item at a first point in time, reflecting a comprehensive aggregation of the stock data inputs from diverse input sources within the distributed network. Each input source, including retailers, point-of-sale systems, and mobile shoppers, contributes data indicative of current inventory levels, allowing for an accurate, real-time overview of item availability. The arrangement of this data into the initial inventory list ensures that the present stock status can be coherently organized and accessible for subsequent management tasks, thereby facilitating efficient monitoring and updates in the inventory management system.

At step 106, the initial inventory list, which can include the first stock value for the first item at the first point in time, can be displayed. This display can be facilitated through a user interface connected to the system, providing real-time visibility to users involved in the inventory management process. The display of the initial inventory list ensures that stakeholders have access to current stock levels, thereby enabling informed decision-making and planning. The displayed information can be accessed via digital platforms such as mobile applications, web interfaces, or enterprise management systems, offering comprehensive availability of data to all relevant participants in the inventory management process.

At step 108, the method evaluates whether an updated stock verification for the first item has been received. This evaluation can be conducted by the system through continuously monitoring the data inputs from the plurality of input sources associated with the distributed network. The system assesses incoming data streams, comparing newly received stock verifications with the initial inventory list already established. When an updated stock verification that can include an updated stock value for the first item at a second point in time can be identified, the system confirms receipt and prepares for subsequent processing. This step ensures the ongoing revision of inventory records, maintaining the accuracy and currency of the inventory management system. Due to shopping events which may occur between the generation of the first stock value and the updated stock value, in some embodiments the updated stock value may be different from the first stock value

At step 110, an updated inventory list that can include the updated stock value for the first item can be generated. This step can be executed after the system ascertains that an updated stock verification has been received, thus indicating a modification in inventory levels. The updated stock value, which has been captured from at least one of the distributed network's input sources, can be utilized to recreate the inventory list with a renewed accuracy reflective of the current item status. This updated inventory list amalgamates all recent stock verification data to portray the existing state of inventory levels accurately. By regenerating the inventory list with this updated stock value, the system ensures that accurate and up-to-date inventory data can be maintained, thereby facilitating effective and real-time oversight and monitoring of inventory resources across various locations.

At step 112, the updated inventory list can be displayed. This display action can include presenting the amended stock value for the first item to ensure the most current data can be readily available. The display of the updated inventory list provides visibility into the latest inventory status, allowing for effective and informed decision-making in inventory management. The display can be viewed via a mobile interface or other digital platforms connected to the system, ensuring accessibility to all pertinent stakeholders in the inventory management process.

A stock value can be the quantifiable amount or count of a specific item available at a given moment in time within an inventory system. It can be derived from data inputs such as direct reporting from retailers, transaction records from point-of-sale systems, or user-submitted verifications. This metric can serve as a fundamental component for generating inventory lists and enables monitoring and tracking of item availability across different locations and timeframes.

Stock verifications, as utilized within the system for inventory management, include data inputs that provide quantifiable representations of item quantities at a given point in time. These verifications may originate from various input sources within a distributed network, encompassing retailers, point-of-sale systems, and user interactions via mobile interfaces. The data submissions can take the form of stock values derived directly from transaction records or other digital inventories maintained by retailers. Alternatively, users may contribute to stock verifications through the submission of images, known as “shelfies,” that visually capture shelf conditions or other inventory storage measures. These images may be accompanied by metadata, such as timestamps or geolocation data, to contextualize the submitted information. By integrating both direct data transmissions and user-generated insights, the system can achieve a comprehensive and flexible approach to inventory quantification and verification, thereby enhancing real-time visibility and accuracy in tracking stock levels.

Input sources can be a range of devices within a distributed network that contribute to the stock verification process within the inventory management system. These devices may include mobile phones, personal computers, and inventory management systems, each playing a role in the inventory data acquisition. Collectively, these input sources enable a multi-path data acquisition process that enhances inventory tracking and management capabilities by improving data accuracy and user engagement.

An inventory list can be a generated record reflecting the precise inventory status of items within a specified inventory at a given point in time. It can be constructed based on one or more stock verifications received from diverse input sources, such as retailers, point-of-sale systems, mobile shoppers, and direct user engagement via mobile interfaces. The inventory list can include stock values, including a first stock value for a first item at a first point in time, and can be regularly updated through continuous submissions of new verifications. This can serve to provide a real-time representation of inventory levels. The inventory list can function as a foundational reference point, facilitating efficient tracking and monitoring of current stock levels while enabling subsequent updates as further verifications are received, thereby enhancing the accuracy and visibility of inventory management processes. An initial inventory list can be an inventory list as determined at a given start time, such as the beginning of a work day.

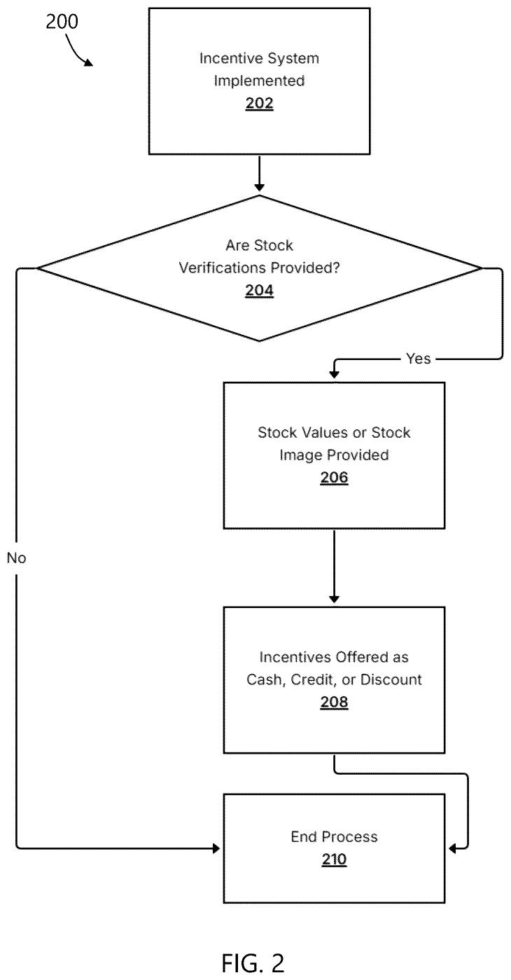

FIG. 2 shows a flow chart illustrating a computer-implemented method 200 for tracking inventory levels within a system designed to facilitate real-time inventory management. Beginning at step 202, an incentive system, which can be aimed to encourage the submission of stock verifications by input sources, can be implemented. At step 204, the method 200 can evaluate whether stock verifications have been provided. If the verifications are received, the process can proceed to step 206, where stock values or a stock image are provided. This can ensures that the verification data can be accurately captured within the system. At step 208 incentives can be offered to input sources in the form of cash, credits, or discounts. These incentives can be designed to further encourage participation and enhance the accuracy of the inventory tracking process. Finally, the process can conclude at step 210. If stock verifications are not provided at step 204, the process cycles back, repeating the evaluation to ensure continuous monitoring and updates are achieved within the inventory management system. This cyclical nature of the process can allow for real-time updates and ongoing engagement from various input sources.

At step 204, the system can evaluate whether stock verifications have been provided. This evaluation process can include actively monitoring incoming data from the plurality of input sources within the distributed network. The system can continuously check for the receipt of stock verification data, which may include stock values or stock images related to inventory items. If the necessary verification data can be detected, the system can identify it and proceed with further processing. This can ensures that the system maintains ongoing engagement with input sources for the accurate and timely update of inventory information.

At step 206, stock verifications can be provided either in the form of stock values or stock images. This process can include capturing and recording quantifiable data or visual representations of inventory items from each input source within the distributed network. Stock values may be directly inputted from transaction records or digital inventories maintained by retailers, while stock images can be captured by mobile users depicting current shelf conditions or inventory storage areas. These images can be enhanced with metadata such as timestamps or geolocation data to ensure accurate context.

At step 208, incentives can be provided to input sources in response to the receipt of stock verifications. Upon evaluating whether stock verifications have been submitted, the system can allocate incentives which may include options such as cash payments, cash-equivalent credits, or product discounts, as explained above.

Embodiments of the present disclosure provide for an incentive system designed to optimize participation and accuracy within a computer-implemented method and system for inventory management. The incentive system can be configured to actively encourage the plurality of input sources—which can include retailers, point-of-sale systems, mobile shoppers, and user interfaces—to provide stock verifications. This motivation can be achieved by offering a range of rewards, such as cash payments, cash-equivalent credits, or product discounts, which are provided in response to the submission of stock verifications. The integration of these incentives into the inventory management process can therefore foster increased participation and trust, thereby contributing to the reliability and comprehensiveness of the inventory tracking system.

In some embodiments, the incentive system can incorporate gamification to further engage input sources in the inventory management process. The gamification layer can be designed to enhance user motivation and sustained participation through interactive elements and reward structures that align with game-like dynamics.

The gamification layer may include features such as user progress tracking, point accumulation, badge collection, and achievement tiers. Users can earn points by submitting stock verifications with higher-value verifications, such as those verified by image and geolocation data, earning more points. As users accumulate points, they may unlock new reward tiers, each offering increased incentives such as exclusive product discounts or recognition on a user community leaderboard, fostering a sense of achievement and community engagement.

Additionally, structured tasks or “quests” can be integrated into the incentive system, providing users with specific objectives or challenges to complete. These quests can be time-bound or location-specific, adding elements of urgency and exploration that enhance user interaction. Augmented Reality (AR) interactive challenges can further augment engagement by creating immersive experiences where users can virtually interact with inventory items or environments, promoting more accurate and frequent stock verifications.

Moreover, gamified rewards—such as virtual trophies or titles—can serve as recognition of user accomplishments, incentivizing continuous participation. The system can also facilitate peer competition and collaboration through community features enabling users to track their progress relative to others, amplifying motivation through social dynamics. By incorporating these gamification strategies, the incentive system effectively engages users, enhancing the reliability and comprehensiveness of inventory data collection, while promoting the seamless integration of community participation within the inventory management framework.

As will be understood to those having skill in the art, a cash-equivalent credits can be a form of pseudo-currency or credits that approximate the value of cash. These credits are typically utilized within specified environments, such as an application, digital marketplace, or physical marketplace, and can be exchanged for goods, services, or discounts as determined by the system's incentive structure and/or the retailer.

As will be understood by one having skill in the art, a stock image can be a captured photograph or representation of a product or a section of stock area, such as a shelf or storage location, that can be utilized as part of the stock verification process. This image may be uploaded by input sources, including users or systems, to serve as visual confirmation of the current inventory levels. The stock image may be accompanied by metadata, which could include time stamps, geolocation data, or other contextual information, enhancing the reliability of the verification. The use of stock images allows for a visual documentation method that complements other stock verification formats, such as data feeds from point-of-sale systems, providing a comprehensive approach to confirming and tracking inventory levels.

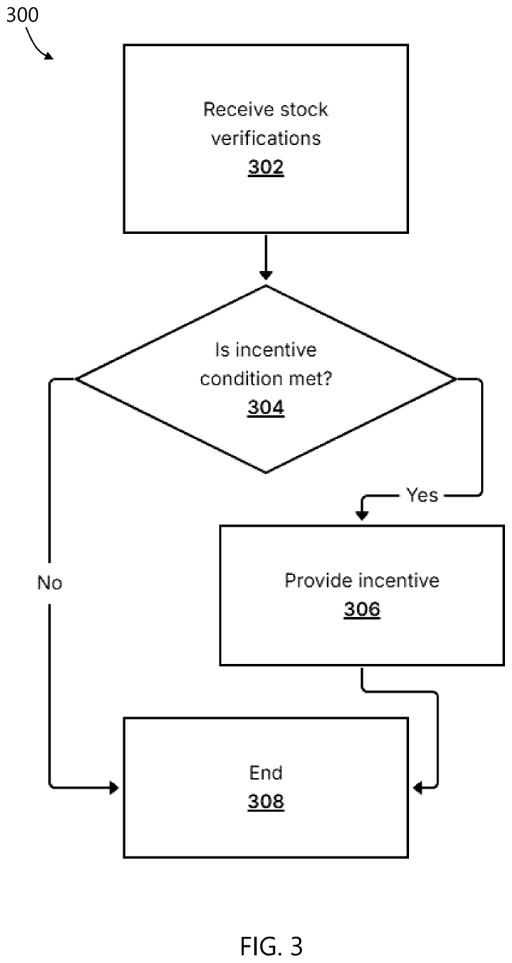

FIG. 3 is a flowchart illustrating a method 300 for incorporating incentives into the stock verification process. At step 302, stock verifications are received. At step 304, the system assesses whether an incentive condition is met. This can include evaluating criteria that determine if providing an incentive is appropriate based on the received stock verifications. If the condition is met, the process advances to step 306, where an incentive can be provided. If the incentive condition is not satisfied at step 304, the process does not provide an incentive and instead loops back to continue receiving additional verifications. The process concludes at step 308, marking the end of the current cycle.

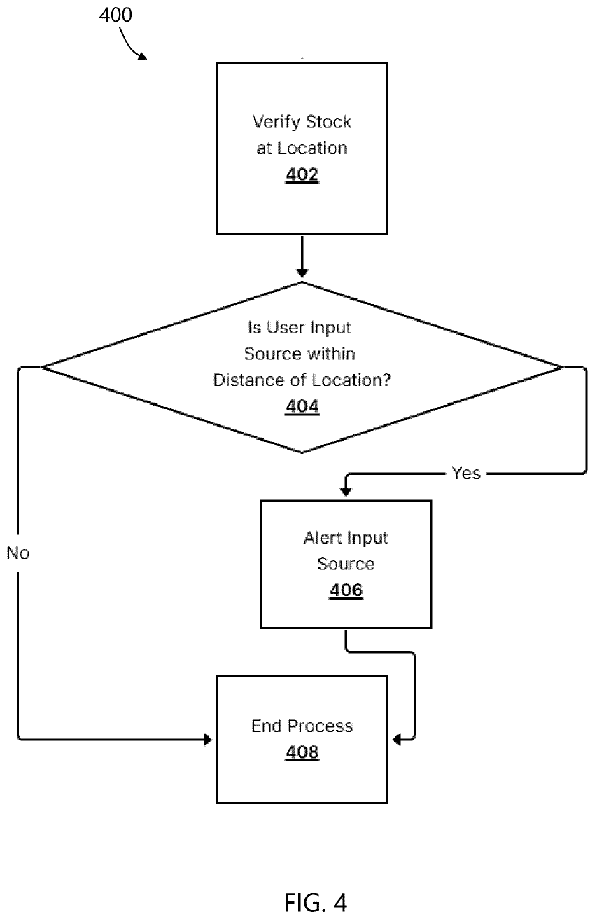

FIG. 4 depicts a method for notifying a user of certain stock conditions based on that user's geographic location. At step 402, stock can be verified at a designated location, such as a physical retail store. At decision step 404, the system determines whether a user input source is within a certain distance of the location. If a user is within the specified distance, the process moves to step 406, where an alert can be sent to the user input source, facilitating location-based engagement. Following the alert in step 406, or if the condition in step 404 is not satisfied, the process concludes at step 408, marking the end of the process.

As will be understood by one having skill in the art, the determination of a designated location within the system for real-time inventory management can include assessing the geographic coordinates or address associated with a particular inventory storage or retail site. This determination may be facilitated through the integration of geolocation technologies, such as GPS (Global Positioning System) data, within the system. Input sources, comprising devices like mobile phones equipped with location-tracking capabilities, can send their current geographic positions to the system. The system can then compare these positions to predefined geolocation markers associated with each inventory site to ascertain whether a user input source is proximally located relative to the designated inventory location. Upon arrival within a predetermined distance from the location, the system may trigger location-based alerts or engagement modules aimed at enhancing the accuracy and relevance of inventory verifications, thereby optimizing inventory management.

As explained with reference to step 406, upon determining that a user input source can be within a certain distance of a designated location, the system can send an alert to the user. This alert can serve as a notification mechanism intended to engage the user in a location-based manner. The alert may be transmitted in the form of a push notification on a mobile device or via an in-app message, providing users with information pertinent to the inventory levels at the nearby location. The alerts are configured to prompt users to purchase retail items, verify stock, or report inventory conditions, thereby facilitating dynamic interaction with the inventory system. In this way, the system can optimize the timeliness and accuracy of inventory updates, leveraging the user's proximity for more relevant inventory management interventions. The use of alerts ensures that users are effectively informed and can participate in the inventory verification process at optimal times, improving the responsiveness of the inventory management system.

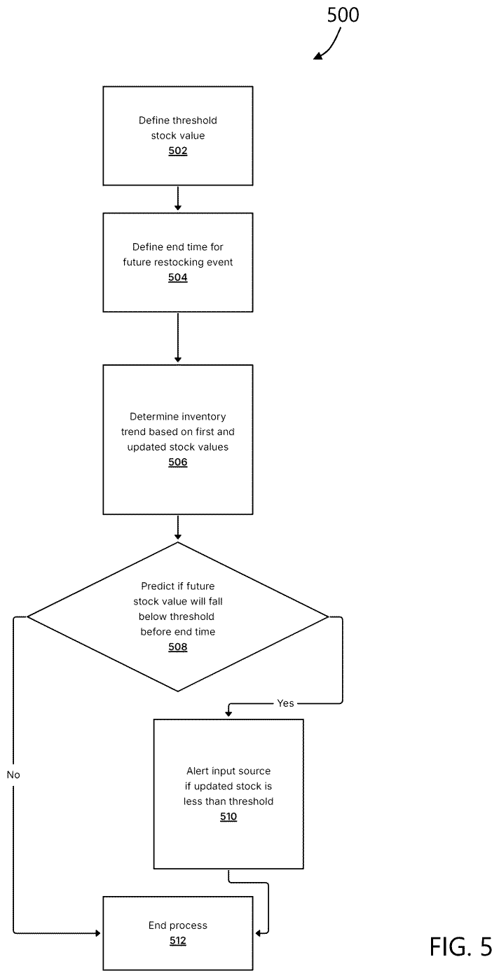

FIG. 5 shows a flowchart illustrating a method 500 within a computer-implemented system for predictive inventory management. At step 502, a threshold stock value can be established. This value can serve as a benchmark to determine when inventory levels may require replenishment. Proceeding to step 504, an end time for a future restocking event can be defined. This step can allow for scheduling and planning inventory management activities in alignment with predicted inventory needs. Step 506 can include determining the inventory trend based on initial and updated stock values. This evaluation facilitates the prediction of future inventory requirements. At step 508, the method can assess whether the future stock value will fall below the defined threshold before the designated end time. In the event that this condition is met, the process can advance to step 510, where an input source can be alerted if the updated stock is less than the threshold. This alert mechanism can enable timely intervention to maintain optimal inventory levels. Finally, at step 512, the process concludes, ensuring that necessary actions have been communicated to relevant stakeholders for efficient inventory management.

Referring back to step 506, the method 500 can determine an inventory trend by analyzing a first stock value and an updated stock value. This step can include computing the difference between these values, which reflects the change in inventory level for the specified item. By continuously monitoring such changes, the system can identify patterns of increase or decrease in stock levels over designated periods. These patterns, or trends, can be instrumental in forecasting future inventory needs, planning restocking schedules, and enhancing overall inventory management efficiency. The resulting trend analysis provides insights into consumption patterns and inventory turnover rates, supporting informed decision-making for stock replenishment and resource allocation.

As will be understood by one having skill in the art, an inventory trend can be an assessment of changes in inventory levels over time, allowing for strategic analysis and planning. An inventory trend can be determined by evaluating stock values at different points in time, specifically comparing initial and updated stock values for particular items.

The calculated trend may be represented graphically, allowing stakeholders to visually assess fluctuations in inventory. Statistical analysis, such as regression analysis, can be applied to historical stock data to predict future inventory behavior. Furthermore, the integration of external data, such as sales forecasts, seasonal variations, and market demand fluctuations, enhances the inventory trend analysis's comprehensiveness. By leveraging machine learning algorithms, the system may continuously refine its trend predictions, adapting to changes in data patterns, thus supporting strategic decision-making and resource allocation in the inventory management process.

Embodiments of the present disclosure provide for emergency inventory management features that assist in responding to emergency situations such as severe weather events, public health crises, or natural disasters. The system can provide functionalities to classify certain items as high-priority inventory when emergencies arise, wherein said functionalities can be either automated by the system or manually input by a user or retailer. These items can include essential goods like bottled water, batteries, or non-perishable foods that are crucial for sustaining individuals during crises.

In some embodiments, system can prioritize the visibility of such high-priority items on consumer platforms, ensuring that users can quickly identify and access them. This assured visibility can aid consumers in locating necessary supplies, thereby enhancing preparedness in emergency scenarios. Further, the system may incorporate alert mechanisms that notify local municipal partners or emergency management organizations when inventory levels of these critical items fall below predefined thresholds. These alerts facilitate timely restocking and distribution plans, ensuring that these essential goods remain available to the public when they are needed most.

In emergency scenarios, the trend prediction function can provide substantial assistance by anticipating the inventory needs of high-priority items that are crucial during crises, such as severe weather events, public health emergencies, or natural disasters. By defining threshold stock values for these essential goods, such as bottled water, batteries, or non-perishable foods, the system can predict when inventory is likely to fall below these critical levels before the planned restocking events. This prediction capability allows retailers and emergency responders to proactively manage inventory by triggering alerts when stocks of essential items are anticipated to run low, ensuring timely replenishment and availability. Furthermore, by integrating with regional emergency alert systems, the trend prediction function can synchronize public communications regarding item availability, helping to maintain adequate supply levels and facilitating efficient distribution of essential items. This integration supports effective crisis management by providing accurate, real-time insights into inventory changes, enabling relevant stakeholders to take appropriate action to mitigate shortages and enhance community readiness.

Some embodiments of the present disclosure can also provide for offline mode capabilities within the system. This offline functionality permits input sources, such as mobile devices, to capture and store stock verification data even when a network connection is not available. When a device enters offline mode, users can record stock verifications locally on the device, which may include stock values, stock images, timestamps, and geolocation data. This functionality can ensure that verification activities can continue without interruption, even in areas with limited or no connectivity, such as rural regions or during emergencies.

Once the device re-establishes a network connection, the system can automatically synchronize the locally stored data with the central inventory database. This synchronization can ensure that all previously captured stock verifications are accurately integrated into the inventory management system, maintaining consistency and continuity in data tracking and inventory updates. This feature can be particularly beneficial for locations that experience intermittent connectivity, allowing for uninterrupted participation in the inventory verification system and ensuring that the most accurate inventory data is maintained.

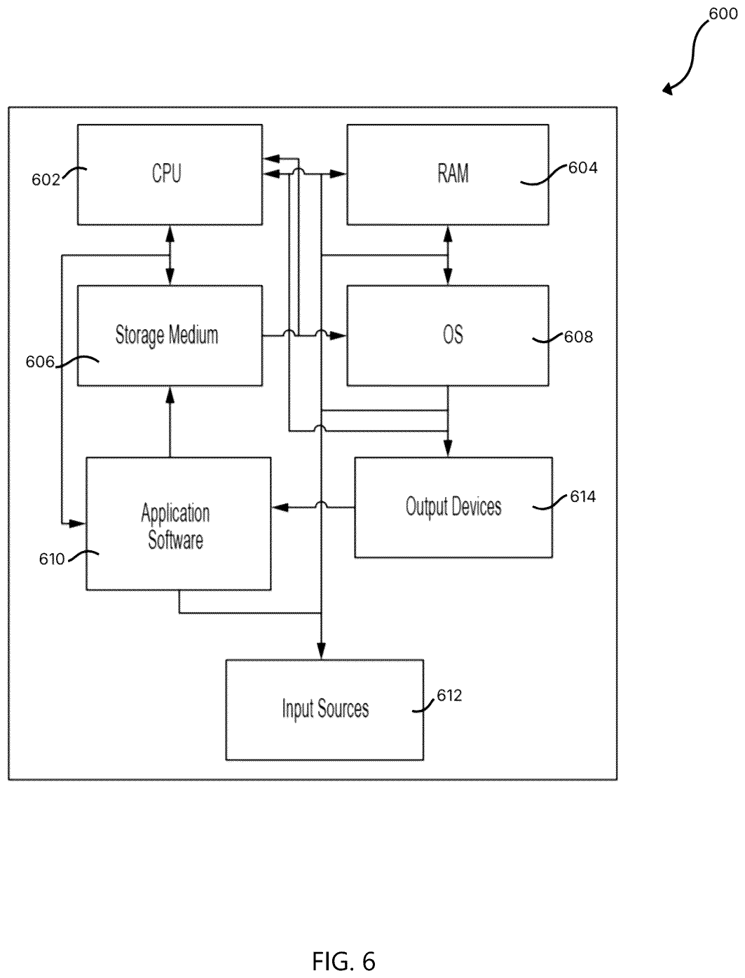

FIG. 6 depicts a schematic overview of an exemplary embodiment of a system 600 capable of performing method 100. In FIG. 6, the system 600 may generally be comprised of: one or more processors, such as a Central Processing Unit (CPU) 602; a memory, such as non-transitory computer-readable medium (e.g., a Random Access Memory (RAM) 604 or alternatively/additionally a storage medium 606 (e.g., read only memory (ROM), hard disk drive, solid state drive, flash memory, cloud storage)); an operating system (OS) 608; one or more application software 610, one or more input devices/means 612 (hereinafter “input devices”) (e.g., keyboard, mouse, microphone, scanner, camera); and one or more output devices/means 614 (hereinafter “output devices”) (e.g., LCD screen, LED display, OLED panel). According to some embodiments, the one or more input sources 612 and the one or more output devices 614 may be combined in a single device, such as one or more touchscreens or one or more communication interfaces (e.g., RS232, Ethernet, Wifi, Bluetooth, USB). The operating system 608 and the one or more application software 610 may be stored in the computer-readable medium 604 and/or the storage medium 606. The components of the system 600 may be connected directly or indirectly to one or more printed circuit boards (such as a mother board). Examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

In some embodiments, data collection and tracking may be facilitated through interactions with mobile interfaces or other digital platforms. Initially, users engaging with the system via mobile devices may be prompted to provide stock verifications through input methods such as entering stock values or capturing and uploading images. These contributions from users can not only update inventory levels but can also form a basis for the collection of relevant user data. The system may track user interactions by monitoring the frequency and timing of stock verification submissions, which aids in understanding user behaviors and patterns in data engagement.

Furthermore, user data may be enriched with metadata that accompanies stock verification submissions. This additional information may include temporal data such as timestamps, indicating when verifications were submitted, as well as geolocation data, determining the user's physical proximity to inventory sites. By analyzing this metadata, the system can ascertain usage trends, assess user engagement levels, and enhance the accuracy of inventory data based on the user's contextual environment.

Additionally, the system may employ unique user identifiers, allowing for the aggregation and analysis of data tied to specific users. This enables the system to build user profiles, tracking historical contributions to inventory verifications and identifying key user metrics, such as reliability scores or participation frequency. By maintaining these profiles, the system can better tailor incentives, such as offering personalized or targeted rewards that align with user preferences and behaviors, encouraging continued engagement and improving the overall inventory tracking process.

In the context of the computer-implemented method and system for real-time inventory management, collecting user data about shopping preferences can be achieved through their interactions within the system. When users engage with the mobile interfaces or other digital platforms to submit stock verifications, they can provide valuable insights into their shopping behaviors and preferences. This data collection process can involve capturing user interactions such as the selection of specific product categories, frequency of verification submissions, and engagement with promotion or incentive systems.

User data related to shopping preferences may further be augmented by metadata accompanying their interactions. This metadata can include information like timestamps, revealing peak activity periods, and geolocation data, indicating preferred shopping locations. Such data can allow the system to discern patterns in user behavior, such as preferred shopping hours, frequently chosen inventory items, or favored products, thereby offering a more tailored user experience.

Moreover, in some embodiments the system can create user profiles that consist of historical interaction patterns and shopping preferences. These profiles can be leveraged to deliver personalized recommendations, targeted promotions, or customized incentives that align with individual user interests, thereby enhancing user satisfaction and driving greater engagement in the inventory management process. This user-centric approach can not only support inventory optimization but can also incentivize continued participation from users by closely aligning inventory offerings with consumer demand.

The detailed description explains embodiments of the disclosure, together with advantages and features, by way of example with reference to the drawings.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

Numerous modifications, alterations, and changes to the described embodiments are possible without departing from the scope of the present invention defined in the claims. It is intended that the present invention need not be limited to the described embodiments, but that it has the full scope defined by the language of the following claims, and equivalents thereof.

1. A computer-implemented method for tracking inventory levels, the method comprising:
receiving a plurality of stock verifications for a plurality of items from a plurality of input sources associated with a distributed network of input sources;
generating an initial inventory list based on the plurality of stock verifications, wherein the initial inventory list includes a first stock value for a first item in inventory at a first point in time;
displaying the initial inventory list that includes the first stock value for the first item inventory at the first point in time;
receiving an updated stock verification that includes an updated stock value for the first item at a second point in time from an input source included in the plurality of input sources associated with the distributed network of input sources;
generating an updated inventory list that includes the updated stock value for the first item; and
displaying the updated inventory list that includes the updated stock value for the first item.

2. The computer-implemented method of claim 1, further comprising an incentive system for incenting the plurality of input sources to provide stock verifications.

3. The computer-implemented method of claim 2, wherein the stock verifications comprise at least one of the stock values or a stock image.

4. The computer-implemented method of claim 2, wherein the incentive system is configured to provide an incentive in response to receiving the stock verifications.

5. The computer-implemented method of claim 3, wherein the incentive comprises at least one of cash, a cash-equivalent credit, or a product discount.

6. The computer-implemented method of claim 1, wherein the updated stock value is different from first stock value.

7. The computer-implemented method of claim 1, wherein the plurality of stock verifications each correspond to a location, and the method further comprises alerting at least one of the input sources when that input source is within a distance of the location.

8. The computer-implemented method of claim 1, further comprising:
defining a threshold stock value;
defining an end time which corresponds to a future restocking event; and
predicting whether a future stock value will fall below the threshold stock value before the end time.

9. The computer implemented method of claim 1, further comprising determining an inventory trend based on at least the first stock value and the updated stock value.

10. The computer implemented method of claim 1, further comprising alerting at least one of the input sources when the updated stock value is less than a threshold stock value.

11. A system for tracking inventory levels across a plurality of locations, the system comprising:
a processor programmed to:
receive a plurality of stock verifications for a plurality of items from a plurality of input sources associated with a distributed network of input sources;
generate an initial inventory list based on the plurality of stock verifications, wherein the initial inventory list includes a first stock value for a first item in inventory at a first point in time;
display the initial inventory list that includes the first stock value for the first item inventory at the first point in time;
receive an updated stock verification that includes an updated stock value for the first item at a second point in time from an input source included in the plurality of input sources associated with the distributed network of input sources;
generate an updated inventory list that includes the updated stock value for the first item; and
display the updated inventory list that includes the updated stock value for the first item.

12. The system of claim 11, wherein the processor is further programed to provide an incentive to the plurality of input sources to provide stock verifications.

13. The system of claim 12, wherein the stock verifications comprise at least one of the stock values or a stock image.

14. The system of claim 12, wherein the incentive comprises at least one of cash, a cash-equivalent credit, or a product discount.

15. The system of claim 11, wherein the updated stock value is different from first stock value.

16. The system of claim 11, wherein the plurality of stock verifications each correspond to a location, and the processor is further programmed to alert at least one of the input sources when that input source is within a distance of the location.

17. The system of claim 11, wherein the processor is further programmed to:
define a threshold stock value;
define an end time which corresponds to a future restocking event; and
predict whether a future stock value will fall below the threshold stock value before the end time.

18. The system of claim 11, wherein the processor is further programmed to determine an inventory trend based on at least the first stock value and the updated stock value.

19. The system of claim 11, wherein the processor is further programmed to alert at least one of the input sources when the updated stock value is less than a threshold stock value.

20. The system of claim 11, wherein at least one of the plurality of input sources comprises a retailer or a point-of-sale system.
